(19) United States
(12) Patent Application Publication
(10) Pub. No.: US 2013/0179950 A1
(43) Pub. Date: Jul. 11, 2013

(54) NETWORK CONNECTION APPARATUS

(71) Applicant: Hidetoshi Yamazaki, Kanagawa (JP)

(72) Inventor: Hidetoshi Yamazaki, Kanagawa (JP)

(73) Assignee: PANASONIC CORPORATION, Kadoma-shi, Osaka (JP)

(21) Appl. No.: 13/822,225

(22) PCT Filed: May 24, 2012
(86) PCT No.: PCT/JP2012/003405

§ 371 Date: Mar. 11, 2013

(30) Foreign Application Priority Data
May 25, 2011 (JP) 2011-117221

(51) Int. Cl. H04L 29/06

(52) U.S. Cl. CPC H04L 63/10
USPC 726/4

(57) ABSTRACT

A DLNA-capable network connection apparatus for communicating with other apparatus in a local network area supplied by an access point (AP) includes an AP detecting part for detecting an AP capable of wireless communication in a place in which the network connection apparatus is located, and a public control part for performing public control corresponding to the AP detected by the AP detecting part based on public setting information about publicity of the network connection apparatus set every AP.

### TECHNICAL FIELD

The present invention relates to a network connection apparatus capable of inhibiting unauthorized access and data leaks.

### BACKGROUND ART

In recent years, a DLNA (Digital Living Network Alliance)-capable apparatus capable of easily using contents of photographs, music, video, etc. in a local network area using a wireless LAN etc., is becoming widespread. The DLNA is guidelines drawn up on the premise that connection to an unspecified number of apparatuses can be made, but the art for protecting privacy is not advocated. Because of this, personal DLNA server information or contents information may be referred to or used by other people in the case of conducting DLNA communication using a public wireless LAN.

According to the art described in Patent Literature 1, a user sets a function held by a DLNA server and a client apparatus using its function and thereby, restrictions can be imposed on the connected client apparatus and the provided function. For example, in the case of activating the DLNA server and participating in a network, a function of the DLNA server is hidden from the client apparatus which is not present in information about the client apparatus set by the user and dummy apparatus notification is provided for the client apparatus. Accordingly, unauthorized access from other client apparatus can be prevented. In addition, when registration work of the client apparatus is done in the DLNA server side, connection to the registered client apparatus can be made. Also, in the art described in Patent Literature 1, in the DLNA server side, the user can set public service (server function) for the registered client apparatus every apparatus in addition to connection registration of the client apparatus.

### CITATION LIST

### Patent Literature

Patent Literature 1: JP-A-2007-324921

### SUMMARY OF INVENTION

### Technical Problem

According to the art described in Patent Literature 1 described above, dummy apparatus notification without the server function is provided for the client apparatus until setting about selection of the public server function and registration of the client apparatus permitting connection are completed in the DLNA server side. Because of this, manipulation of the DLNA server from the client apparatus side results in no response or an error.

Also, a user does not necessarily store all setting information about the public service or the client apparatus to which connection is permitted. As a result, failure in setting applies stress to the user. Also, every time the client apparatus to which connection is permitted is newly increased, or every time the contents of service every client apparatus are changed, work in which, for example, the user changes the setting is a burden on the user.

Thus, the user was burdened and sacrificed in order to prevent unauthorized access to the DLNA server and data leaks. That is, it was difficult to reduce a burden on the user while preventing the unauthorized access to the DLNA server and the data leaks. However, in future, it is expected that terminals using a DLNA function through a public wireless LAN are widely distributed. As a result, it is probably important for the user to be able to easily change operation setting of the DLNA server every network used.

An object of the invention is to provide a network connection apparatus capable of reducing a burden on a user about setting every access point of a DLNA-capable apparatus capable of inhibiting unauthorized access and data leaks.

### Solution to Problem

According to one aspect of the present invention, there is provided a DLNA-capable network connection apparatus configured to communicate with other apparatus in a local network area supplied by an access point, comprising: an access point detecting part configured to detect an access point capable of wireless communication in a place in which said network connection apparatus is located, and a public control part configured to perform public control corresponding to the access point detected by the access point detecting part based on public setting information about publicity of said network connection apparatus set every access point, wherein in the case of being set in the public setting information so as not to publicize said network connection apparatus when said network connection apparatus is located inside a network area of a specific access point, when the access point detected by the access point detecting part is an access point other than the specific access point, the public control part makes a retrieval request for the other apparatus and publicizes public information about said network connection apparatus when the retrieval request from the other apparatus is received and on the other hand, when the access point detected by the access point detecting part is the specific access point, the public control part does not make a retrieval request for the other apparatus and does not publicize public information about said network connection apparatus even when the retrieval request from the other apparatus is received.

According to another aspect of the present invention, there is provided a DLNA-capable network connection apparatus configured to communicate with other apparatus in a local network area supplied by an access point, comprising: an access point detecting part configured to detect an access point capable of wireless communication in a place in which said network connection apparatus is located, a public control part configured to perform public control corresponding to the access point detected by the access point detecting part based on public setting information about publicity of said network connection apparatus set every access point, and a specific apparatus determining part configured to determine whether public information about a specific apparatus is included in public information about other apparatus obtained from the other apparatus, wherein in the case of being set in the public setting information so as not to publicize said network connection apparatus except the specific apparatus when said network connection apparatus is located inside a network area of a specific access point, when the access point detected by the access point detecting part is an access point other than the specific access point, the public control part makes a retrieval request for the other apparatus and publicizes public information about said network connection apparatus when the retrieval request from the other apparatus is received and on the other hand, when the access point detected by the access point detecting part is the specific access point, the public control part makes a retrieval request for the other apparatus and publicizes public information about said network connection apparatus to only the specific apparatus when the specific apparatus determining part determines that public information about the specific apparatus is included in public information about the other apparatus obtained.

In the above network connection apparatus, an apparatus name at the time of non-publicity may be set in the public setting information, the apparatus name being an apparatus name of said network connection apparatus at the time when said network connection apparatus is located inside a network area of a specific access point and being common to an apparatus name of the specific apparatus, and the specific apparatus determining part determines whether the apparatus name at the time of non-publicity is included in public information about other apparatus obtained from the other apparatus.

The above network connection apparatus may further comprise a processing part configured to perform processing so as to return error notification or dummy data to a download request for contents with respect to said network connection apparatus when public information about other apparatus obtained from the specific apparatus indicates that the specific apparatus is an apparatus having a server function in DLNA.

The above network connection apparatus may further comprise a warning display processing part configured to perform processing so as to display a warning that plural pieces of public information about the specific apparatus are included in public information about other apparatus obtained from the other apparatus.

### Advantageous Effects of Invention

According to the network connection apparatus according to the invention, a burden on a user about setting every access point of a DLNA-capable apparatus capable of inhibiting unauthorized access and data leaks can be reduced.

### BRIEF DESCRIPTION OF DRAWINGS

FIG. 1 is a diagram showing one example of a state in which plural DLNA-capable apparatuses are present inside a local network area supplied by an access point (AP).

FIG. 2 is a block diagram showing an internal configuration of a DLNA server of a first embodiment and a relation among the DLNA server, an access point and other apparatus.

FIG. 3 is a block diagram showing an internal configuration of a DLNA server of a second embodiment and a relation among the DLNA server, an access point and other apparatus.

FIG. 4 is a block diagram showing an internal configuration of a DLNA server of a third embodiment and a relation among the DLNA server, an access point and other apparatus.

FIG. 5 is a block diagram showing an internal configuration of a DLNA server of a fourth embodiment and a relation among the DLNA server, an access point and other apparatus.

### DESCRIPTION OF EMBODIMENTS

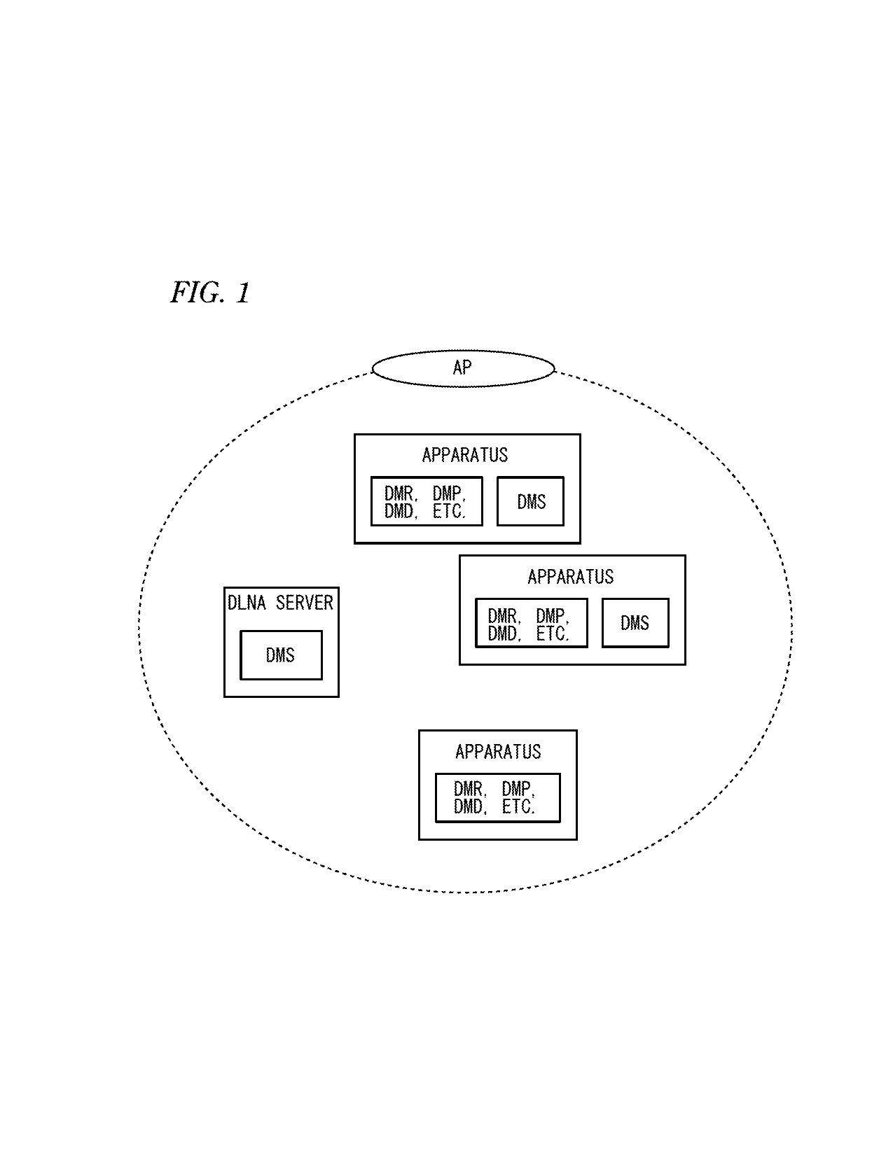

Embodiments of the invention will hereinafter be described with reference to the drawings. FIG. 1 is a diagram showing one example of a state in which plural DLNA (Digital Living Network Alliance)-capable apparatuses are present inside a local network area supplied by an access point (AP). As shown in FIG. 1, a function had by the DLNA-capable apparatus includes a DMS (Digital Media Server), a DMR (Digital Media Renderer), a DMP (Digital Media Player), a DMD (Digital Media Downloader), etc. A DLNA server is an apparatus having a DMS function. In addition, in the following explanation, the DLNA-capable apparatus is simply called an “apparatus”.

### First Embodiment

In a first embodiment, a DLNA server selects whether or not to publicize a DMS function according to a supply area of an access point at which the DLNA server is located.

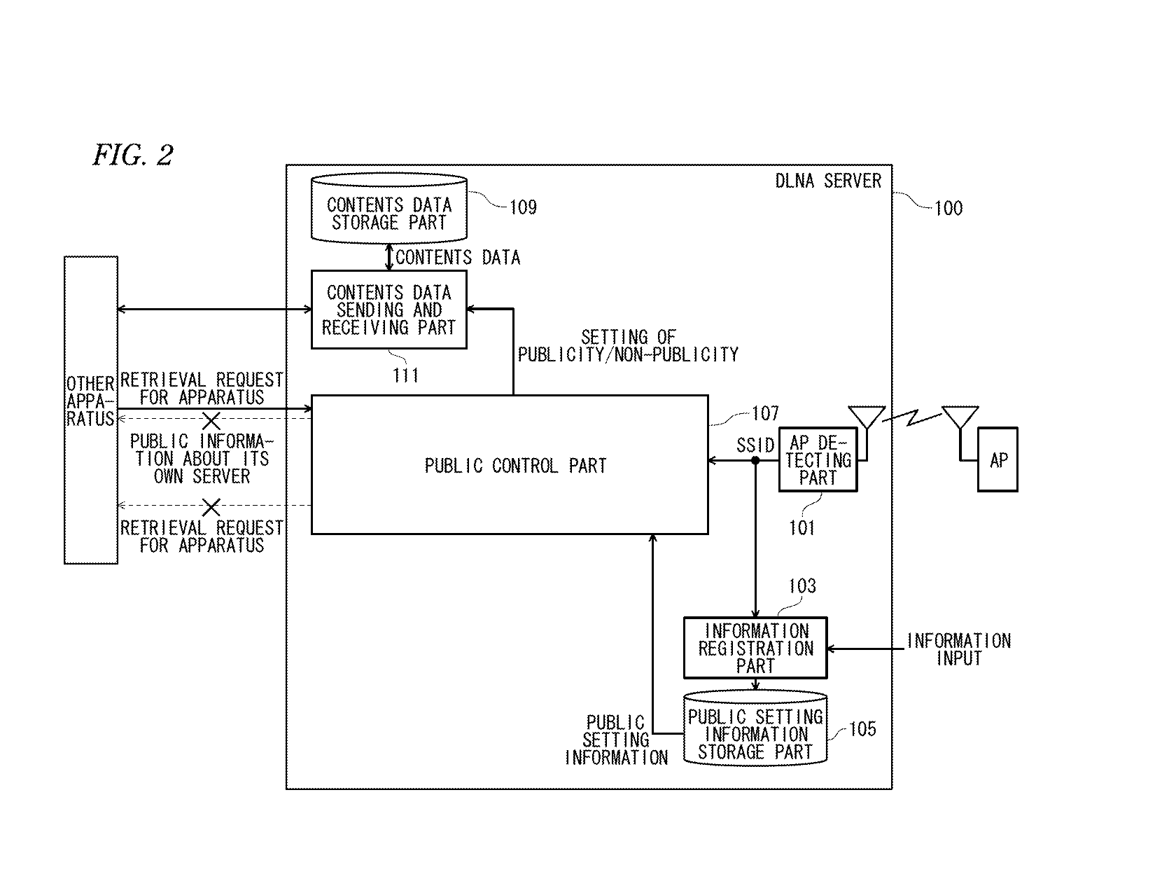

FIG. 2 is a block diagram showing an internal configuration of the DLNA server of the first embodiment and a relation among the DLNA server, the access point and other apparatus. As shown in FIG. 2, the DLNA server 100 includes an AP detecting part 101, an information registration part 103, a public setting information storage part 105, a public control part 107, a contents data storage part 109, and a contents data sending and receiving part 111.

The AP detecting part 101 detects an access point (AP) capable of wireless communication in a place in which the DLNA server 100 of the present embodiment is located. The AP detecting part 101 notifies the information registration part 103 and the public control part 107 of an SSID (Service Set IDentifier) which is an identifier of the detected access point.

The information registration part 103 records public setting information about the DLNA server 100 at the time when the DLNA server 100 is located inside an area of an access point of the SSID notified from the AP detecting part 101 on the public setting information storage part 105. The public setting information is information as to whether or not to publicize a DMS function, and a user of the DLNA server 100 sets the public setting information in the information registration part 103 every SSID. The public setting information storage part 105 stores the public setting information registered by the information registration part 103.

The public control part 107 reads the public setting information corresponding to the SSID notified from the AP detecting part 101 out of the public setting information storage part 105, and performs operation according to the contents of setting indicated by the public setting information. That is, when the public setting information read out indicates publicity of the DMS function, the public control part 107 broadcasts a retrieval request for other apparatus located inside the same area, and publicizes public information about its own server when the retrieval request from other apparatus is received. On the other hand, when the public setting information read out indicates non-publicity of the DMS function, the public control part 107 does not broadcast the retrieval request for other apparatus, and does not publicize the public information about its own server even when the retrieval request from other apparatus is received.

The contents data storage part 109 stores contents data of photographs, music, video, etc. The contents data sending and receiving part 111 reads the contents data out of the contents data storage part 109 to send the contents data or receives the contents data uploaded from other apparatus in the case of receiving a download request for the contents data when the DLNA server 100 is set so as to publicize the DMS function. In addition, the contents data sending and receiving part 111 does not operate when the DLNA server 100 is set so as not to publicize the DMS function.

According to the present embodiment as described above, when the DLNA server 100 of the present embodiment is located inside an area of an access point set so as not to publicize the DMS function, a retrieval request for other apparatus is not broadcast and even when the retrieval request from other apparatus is received, public information about its own server is not publicized. Consequently, when the DLNA server is located inside an area of a specific access point, the presence of the DLNA server is not recognized by other apparatus. As a result, unauthorized access to the DLNA server 100 from other apparatus and data leaks out of the DLNA server 100 can be prevented. Also, a user can set publicity/non-publicity of the DMS function in the DLNA server every area supplied by an access point, and a burden on the user about its setting is light.

### Second Embodiment

In a second embodiment, when a DLNA server is set so as not to publicize a DMS function, the DLNA server provides the DMS function for only a specific preset apparatus.

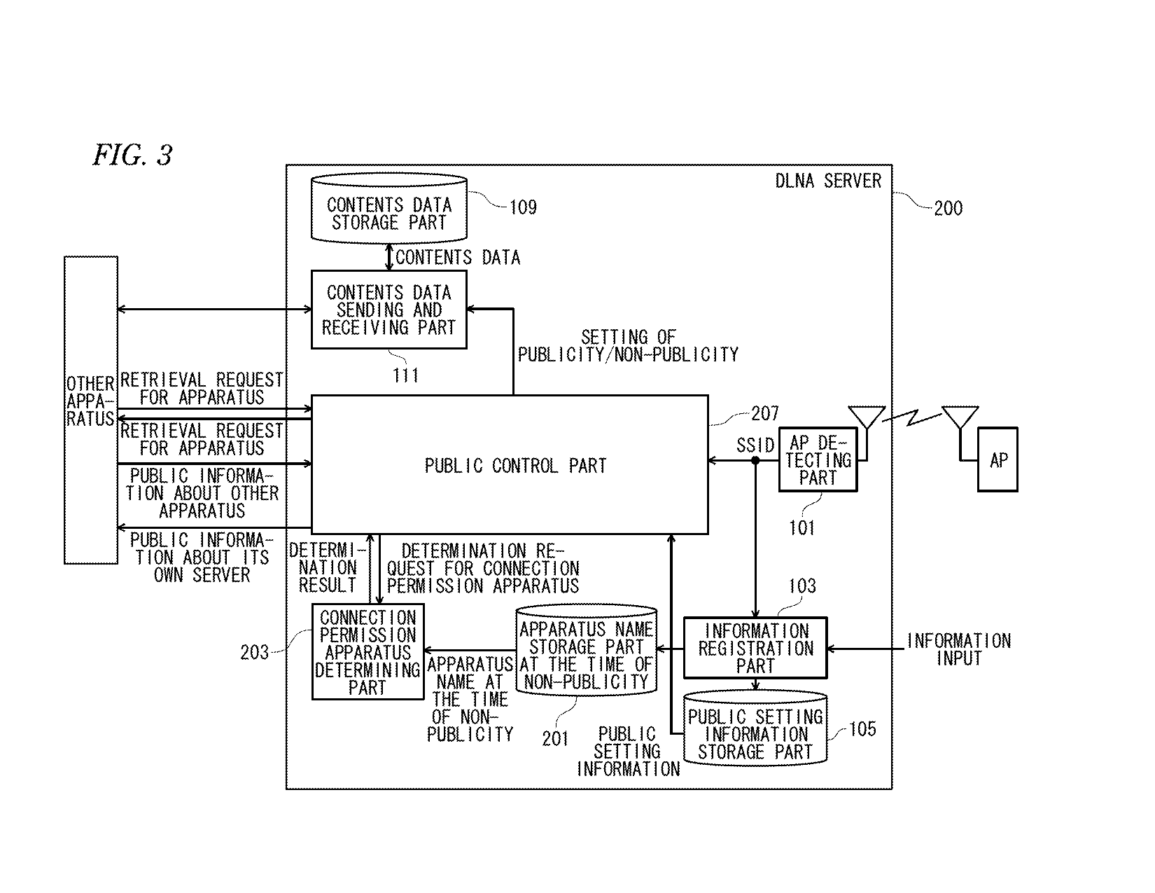

FIG. 3 is a block diagram showing an internal configuration of the DLNA server of the second embodiment and a relation among the DLNA server, an access point and other apparatus. As shown in FIG. 3, the DLNA server 200 of the second embodiment further includes an apparatus name storage part 201 at the time of non-publicity, and a connection permission apparatus determining part 203 in addition to components included by the DLNA server 100 of the first embodiment. However, a public control part 207 of the present embodiment partially differs from the public control part 107 of the first embodiment in operation. Except this point, the second embodiment is similar to the first embodiment and in FIG. 3, the same reference numerals are assigned to the components common to FIG. 2.

Like the first embodiment, the public control part 207 reads public setting information corresponding to an SSID notified from an AP detecting part 101 out of a public setting information storage part 105, and performs operation according to the contents of setting indicated by the public setting information. Also, the public control part 207 is similar to the public control part 107 of the first embodiment in that when the public setting information read out indicates non-publicity of the DMS function, public information about its own server is not publicized even when a retrieval request from other apparatus is received, but the public control part 207 differs from the public control part 107 of the first embodiment in that a retrieval request for other apparatus is broadcast and public information about its own server is publicized to only a specific apparatus determined using public information about other apparatus obtained. In addition, when the public information about other apparatus is obtained from other apparatus, the public control part 207 makes a request for determining whether the apparatus of each information is a specific apparatus in which connection to the DLNA server 200 is permitted to the connection permission apparatus determining part 203.

The apparatus name storage part 201 at the time of non-publicity stores an apparatus name (apparatus name at the time of non-publicity) which the DLNA server 200 of the present embodiment publicizes at the time of non-publicity of the DMS function. In addition, the apparatus name at the time of non-publicity is common to a name given to an apparatus to which the DLNA server 200 permits connection at the time of non-publicity of the DMS function. Also, a user of the DLNA server 200 previously stores the apparatus name at the time of non-publicity through an information registration part 103 in the apparatus name storage part 201 at the time of non-publicity.

When a determination request for the apparatus to which connection to the DLNA server 200 is permitted is received from the public control part 207, the connection permission apparatus determining part 203 determines whether an apparatus matching with the apparatus name at the time of non-publicity read out of the apparatus name storage part 201 at the time of non-publicity is included in other apparatuses corresponding to the public information about each of the other apparatuses received by the public control part 207. When the apparatus matching with the apparatus name at the time of non-publicity is not included, the connection permission apparatus determining part 203 notifies the public control part 207 of that effect as a determination result. When the apparatus matching with the apparatus name at the time of non-publicity is included, the connection permission apparatus determining part 203 notifies the public control part 207 of information about the matching apparatus as a determination result. The apparatus to which the public control part 207 publicizes public information about its own server of the DLNA server 200 is only other apparatus matching with the apparatus name at the time of non-publicity. In addition, the apparatus name included in the public information about its own server is the apparatus name at the time of non-publicity.

According to the present embodiment as described above, when the DLNA server 200 of the present embodiment is located inside an area of an access point set so as not to publicize the DMS function, public information about its own server is not publicized even when a retrieval request from other apparatus is received, and the retrieval request for other apparatus is broadcast and the public information about its own server is publicized to only a specific apparatus determined using public information about other apparatus obtained. That is, when the DLNA server is located inside an area of a specific access point, connection is permitted to only the specific apparatus while the presence of the DLNA server is not recognized by other apparatus. Consequently, in a state capable of communication with the specific apparatus, unauthorized access to the DLNA server 200 from other apparatus and data leaks out of the DLNA server 200 can be prevented. Also, a user can set publicity/non-publicity of the DMS function in the DLNA server every area supplied by an access point and also, the user can freely set the apparatus name at the time of non-publicity, so that a burden on the user about these settings is light.

### Third Embodiment

When a specific apparatus has a DMS function even in a state in which a DLNA server is connected to only the specific apparatus and also the presence of the DLNA server is not recognized by other apparatus, the other apparatus can be connected to the specific apparatus. As a result, contents may leak out of the DLNA server through the specific apparatus. In a third embodiment, in the case where a specific apparatus for which a DLNA server provides a DMS function has the DMS function when the DLNA server is set so as not to publicize the DMS function, only error notification or dummy data sending is performed even when a download request for contents data is received from the specific apparatus.

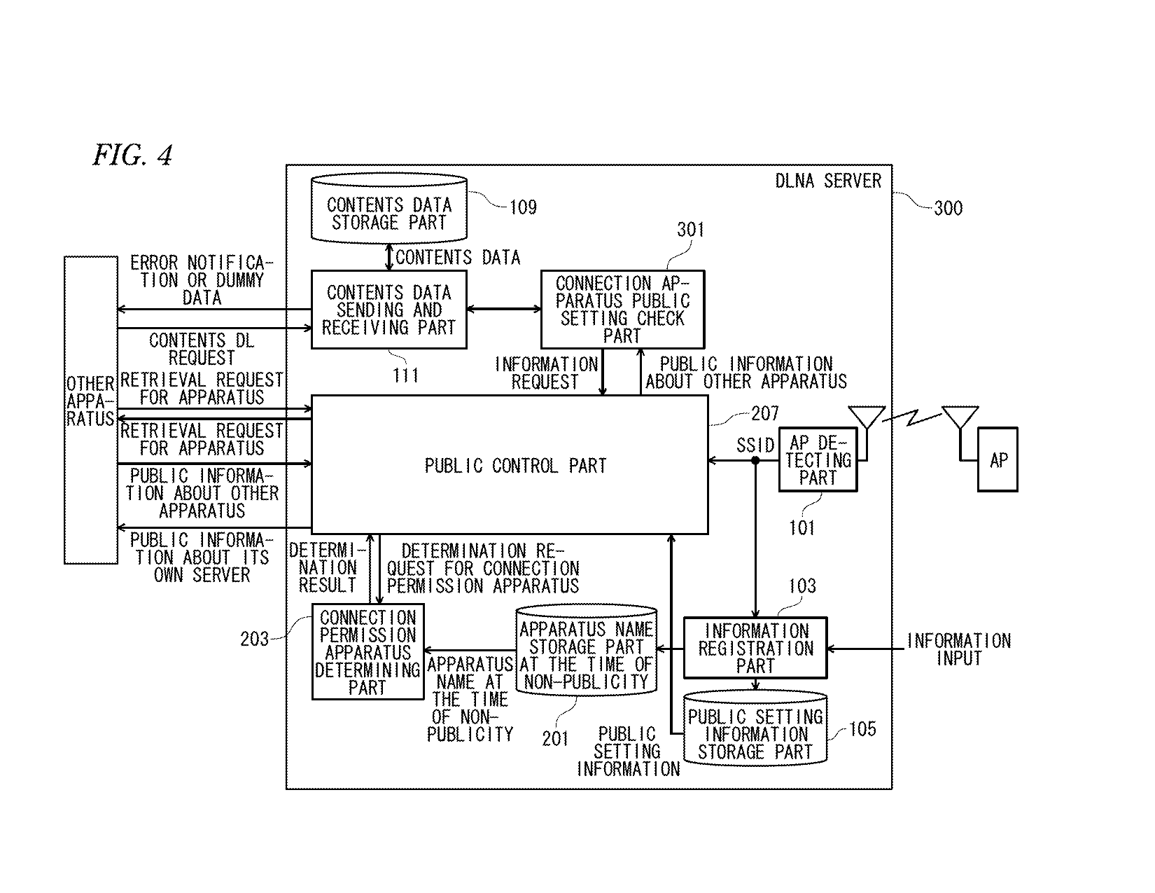

FIG. 4 is a block diagram showing an internal configuration of the DLNA server of the third embodiment and a relation among the DLNA server, an access point and other apparatus. As shown in FIG. 4, the DLNA server 300 of the third embodiment further includes a connection apparatus public setting check part 301 in addition to components included by the DLNA server 200 of the second embodiment. Except this point, the third embodiment is similar to the second embodiment and in FIG. 4, the same reference numerals are assigned to the components common to FIG. 3.

The connection apparatus public setting check part 301 decides whether or not a specific apparatus to which connection is permitted has a DMS function even in the case of being located inside an area of an access point set so as not to publicize the DMS function from public information about other apparatus of the specific apparatus acquired by a public control part. Further, the connection apparatus public setting check part 301 performs processing so as to return error notification or dummy data when the DLNA server 300 receives a download request (contents DL request) for contents data from the specific apparatus having the DMS function.

Consequently, according to the present embodiment, contents leaks out of the DLNA server 300 through the specific apparatus having the DMS function can be prevented.

### Fourth Embodiment

In a fourth embodiment, when a DLNA server is set so as not to publicize a DMS function and provides the DMS function for only a specific preset apparatus, the DLNA server warns that it is in a state capable of connection to the DLNA server since an apparatus name of other apparatus other than the specific apparatus matches with an apparatus name at the time of non-publicity.

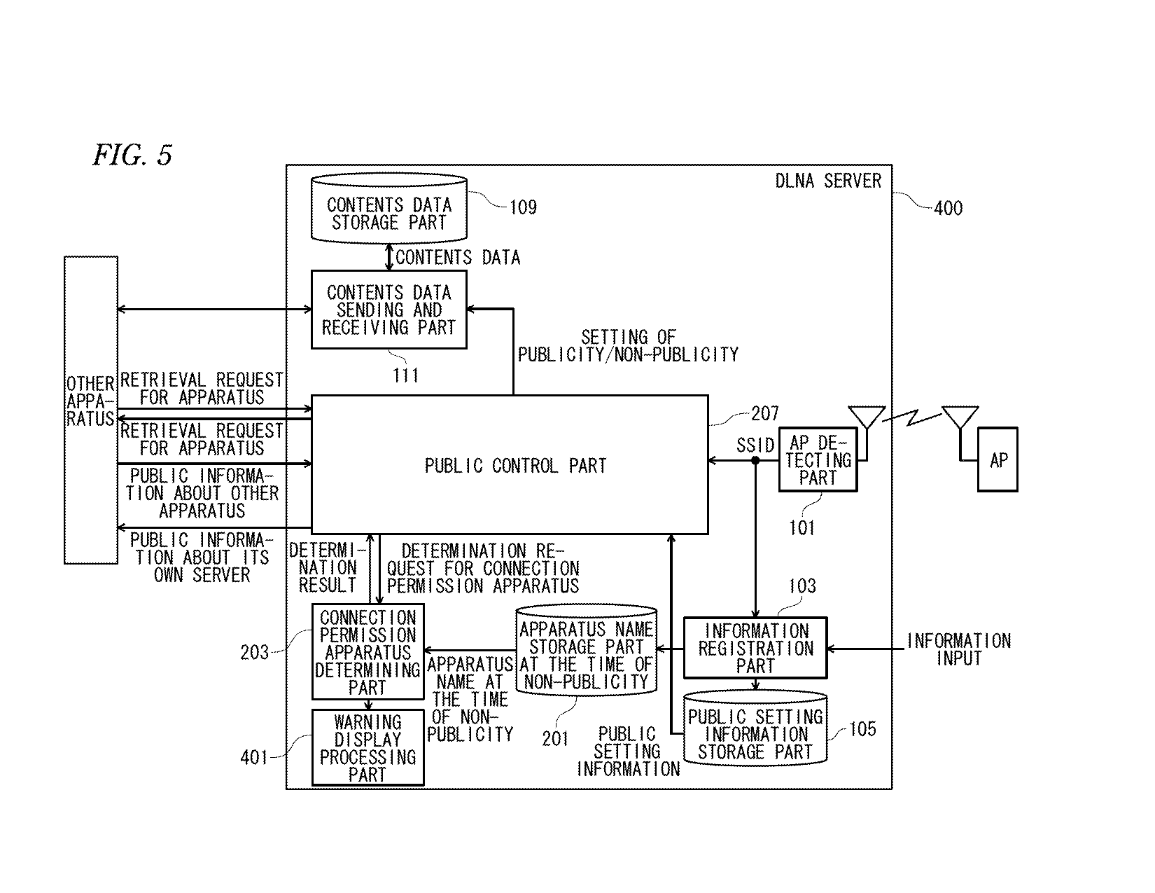

FIG. 5 is a block diagram showing an internal configuration of the DLNA server of the fourth embodiment and a relation among the DLNA server, an access point and other apparatus. As shown in FIG. 5, the DLNA server 400 of the fourth embodiment further includes a warning display processing part 401 in addition to components included by the DLNA server 200 of the second embodiment. Except this point, the fourth embodiment is similar to the second embodiment and in FIG. 5, the same reference numerals are assigned to the components common to FIG. 3.

The warning display processing part 401 performs processing so as to display a warning indicating that other unexpected apparatus is in a state capable of connection to the DLNA server 400 on a display (not shown) when a connection permission apparatus determining part 203 determines that there are plural specific apparatuses capable of connection to the DLNA server 400, that is, when plural apparatuses matching with an apparatus name at the time of non-publicity are included.

Consequently, according to the present embodiment, a user can prevent unauthorized access to the DLNA server 400 from other unexpected apparatus and data leaks out of the DLNA server 400. In addition, the DLNA server 300 of the third embodiment may be provided with the warning display processing part 401 of the present embodiment.

While the present invention has been described in detail, or with reference to the specific embodiments, it is apparent for those skilled in the art that the invention may be modified and changed in various manners without departing from the scope and spirit of the invention.

This application is based on Japanese Patent Application (Japanese Patent Application No. 2011-117221) filed on May 25, 2011, the disclosure of which is incorporated herein by reference in its entirety.

### INDUSTRIAL APPLICABILITY

A network connection apparatus according to the invention is useful as, for example, a DLNA server capable of reducing a burden on a user about setting every access point of a DLNA-capable apparatus capable of inhibiting unauthorized access and data leaks.

### REFERENCE SIGNS LIST

100,200,300,400 DLNA SERVER
101 AP DETECTING PART
103 INFORMATION REGISTRATION PART
105 PUBLIC SETTING INFORMATION STORAGE PART
107,207 PUBLIC CONTROL PART
109 CONTENTS DATA STORAGE PART
111 CONTENTS DATA SENDING AND RECEIVING PART
201 APPARATUS NAME STORAGE PART AT THE TIME OF NON-PUBLICITY
203 CONNECTION PERMISSION APPARATUS DETERMINING PART
301 CONNECTION APPARATUS PUBLIC SETTING CHECK PART
401 WARNING DISPLAY PROCESSING PART

1. A DLNA-capable network connection apparatus configured to communicate with other apparatus in a local network area supplied by an access point, comprising:
an access point detecting part configured to detect an access point capable of wireless communication in a place in which said network connection apparatus is located, and
a public control part configured to perform public control corresponding to the access point detected by the access point detecting part based on public setting information about publicity of said network connection apparatus set every access point,
wherein in the case of being set in the public setting information so as not to publicize said network connection apparatus when said network connection apparatus is located inside a network area of a specific access point, when the access point detected by the access point detecting part is an access point other than the specific access point, the public control part makes a retrieval request for the other apparatus and publicizes public information about said network connection apparatus when the retrieval request from the other apparatus is received and on the other hand, when the access point detected by the access point detecting part is the specific access point, the public control part does not make a retrieval request for the other apparatus and does not publicize public information about said network connection apparatus even when the retrieval request from the other apparatus is received.

2. A DLNA-capable network connection apparatus configured to communicate with other apparatus in a local network area supplied by an access point, comprising:
an access point detecting part configured to detect an access point capable of wireless communication in a place in which said network connection apparatus is located,
a public control part configured to perform public control corresponding to the access point detected by the access point detecting part based on public setting information about publicity of said network connection apparatus set every access point, and
a specific apparatus determining part configured to determine whether public information about a specific apparatus is included in public information about other apparatus obtained from the other apparatus,
wherein in the case of being set in the public setting information so as not to publicize said network connection apparatus except the specific apparatus when said network connection apparatus is located inside a network area of a specific access point, when the access point detected by the access point detecting part is an access point other than the specific access point, the public control part makes a retrieval request for the other apparatus and publicizes public information about said network connection apparatus when the retrieval request from the other apparatus is received and on the other hand, when the access point detected by the access point detecting part is the specific access point, the public control part makes a retrieval request for the other apparatus and publicizes public information about said network connection apparatus to only the specific apparatus when the specific apparatus determining part determines that public information about the specific apparatus is included in public information about the other apparatus obtained.

3. A network connection apparatus as claimed in claim 2, wherein an apparatus name at the time of non-publicity is set in the public setting information, the apparatus name being an apparatus name of said network connection apparatus at the time when said network connection apparatus is located inside a network area of a specific access point and being common to an apparatus name of the specific apparatus, and the specific apparatus determining part determines whether the apparatus name at the time of non-publicity is included in public information about other apparatus obtained from the other apparatus.

4. A network connection apparatus as claimed in claim 2, further comprising a processing part configured to perform processing so as to return error notification or dummy data to a download request for contents with respect to said network connection apparatus when public information about other apparatus obtained from the specific apparatus indicates that the specific apparatus is an apparatus having a server function in DLNA.

5. A network connection apparatus as in claim 2, further comprising a warning display processing part configured to perform processing so as to display a warning that plural pieces of public information about the specific apparatus are included in public information about other apparatus obtained from the other apparatus.
